(19) United States
(12) Patent Application Publication
(10) Pub. No.: US 2026/0361027 A1
(43) Pub. Date: Nov. 12, 2026

(54) MAGNETIC CONNECTION SYSTEM, MAGNETIC CONNECTOR AND ELECTRONIC DEVICE HAVING A MAGNETIC CONNECTOR

(71) Applicant: Razer (ASIA-PACIFIC) PTE LTD., Singapore (SG)

(72) Inventors: Chris WU, Singapore (SG); Jake YANG, Singapore (SG); Kate KU, Singapore (SG)

(73) Assignee: Razer (ASIA-PACIFIC) PTE LTD., Singapore (SG)

(21) Appl. No.: 19/130,623

(22) PCT Filed: Feb. 10, 2023
(86) PCT No.: PCT/SG2023/050072

§ 371 Date: May 16, 2025

(51) Int. Cl. H01R 13/62

(52) U.S. Cl. CPC H01R 13/6205

(57) ABSTRACT

In some embodiments, a magnetic connection system is provided. The system includes a first connector and a second connector. The first connector includes a first magnetic element having a magnetic plane and a terminal assembly protruding from the magnetic plane of the first magnetic element. The terminal assembly includes a first guiding component. The second connector is configured to receive the first connector so as to establish an electrical connection. The second connector includes a receptacle configured to receive the first connector and a second magnetic element disposed adjacent to the receptacle of the second connector. The second connector includes a second guiding component configured to couple with the first guiding component in a manner that the first connector is received by the second connector in a solitary predetermined direction non-parallel to the magnetic plane of the first magnetic element of the first connector.

### TECHNICAL FIELD

Various embodiments relate to a magnetic connection system, a magnetic connector device and an electronic device having a magnetic connector.

### BACKGROUND

Electronic devices, such as laptop computers, typically use DC power supplied from a transformer connected to a conventional AC power supply. An attach-type electrical connector device using a magnet has been introduced. The attach-type electrical connector device has a plurality of connector pins and at least one magnet is installed on each of both sides of the connector pin. A connector connection portion may be damaged by an impact randomly applied from the outside.

Therefore, there exists a need for providing an improved magnetic connection system.

### SUMMARY

According to a first aspect of the present disclosure, a magnetic connection system is provided. The system may include: a first connector, wherein the first connector comprises a first magnetic element having a magnetic plane and a terminal assembly protruding from the magnetic plane of the first magnetic element, and wherein the terminal assembly comprises a first guiding component; a second connector configured to receive the first connector so as to establish an electrical connection, wherein the second connector comprises a receptacle configured to receive the first connector and a second magnetic element disposed adjacent to the receptacle of the second connector, and wherein the second connector comprises a second guiding component configured to couple with the first guiding component in a manner that the first connector is received by the second connector in a solitary predetermined direction non-parallel to the magnetic plane of the first magnetic element of the first connector.

According to a second aspect of the present disclosure, a magnetic connector device for electrically connecting to an electronic device is provided. The magnetic connector device may include: a cable; and a first connector installed at one end of the cable for connecting to a second connector of the electronic device, the first connector comprising: a first magnetic element having a magnetic plane; and a terminal assembly protruding from the magnetic plane of the first magnetic element, wherein the terminal assembly comprises a first guiding component; wherein the first guiding component of the first connector is configured to couple with a second guiding component of the second connector of the electronic device in a manner that the first connector is connected to the second connector of the electronic device in a solitary predetermined direction non-parallel to the magnetic plane of the first magnetic element.

According to a second aspect of the present disclosure, an electronic device is provided. The electronic device may include: a second connector configured to receive a first connector of a magnetic connector device, the second connector comprising: a receptacle configured to receive the first connector; a second magnetic element disposed adjacent to the receptacle of the second connector; and a second guiding component, wherein the second guiding component is configured to couple with a first guiding component of the first connector of the magnetic connector device in a manner that the first connector is received by the second connector in a solitary predetermined direction non-parallel to a magnetic plane of a first magnetic element of the first connector.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the disclosure. In the following description, various embodiments of the disclosure are described with reference to the following drawings, in which:

FIG. 1A shows a perspective view of an example magnetic connection system, according to various embodiments; FIG. 1B shows a side view of the example magnetic connection system of FIG. 1A, according to various embodiments.

FIG. 2A shows a bottom perspective view of an example magnetic connector, according to various embodiments; and FIG. 2B shows a top perspective view of the example magnetic connector of FIG. 2A, according to various embodiments.

FIG. 3 shows an exploded of the example magnetic connector of FIG. 2A, according to various embodiments.

FIG. 4A shows a top view of an example component of the example magnetic connector of FIG. 2A, according to various embodiments; FIG. 4B shows a bottom view of the example component of the example magnetic connector of FIG. 4A, according to various embodiments.

FIG. 5 shows a perspective view of an example magnetic connector of an electronic device, according to various embodiments.

FIG. 6A shows a front perspective view of the example magnetic connector of the electronic device of FIG. 5, according to various embodiments; FIG. 6B shows a back perspective view of the example magnetic connector of the electronic device of FIG. 5, according to various embodiments.

FIG. 7A shows a top view of the example magnetic connection system of FIG. 1A in connection, according to various embodiments; FIG. 7B shows a perspective view of the example magnetic connection system of FIG. 1A in connection, according to various embodiments.

FIG. 8 shows a cross-section view of the the example magnetic connection system of FIG. 1A in connection, according to various embodiments.

### DETAILED DESCRIPTION

The following detailed description refers to the accompanying drawings that show, by way of illustration, specific details, and embodiments in which the disclosure may be practiced. These embodiments are described in sufficient detail to enable those skilled in the art to practice the disclosure. Other embodiments may be utilized, and structural, logical, optical and electrical changes may be made without departing from the scope of the disclosure. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

It should be understood that the terms “on”, “over”, “top”, “bottom”, “down”, “side”, “back”, “left”, “right”, “front”, “back”, “lateral”, “side”, “up”, “down”, “vertical”, “horizontal” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the “or” is intended to include “and” unless the context clearly indicates otherwise.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Approximating language, as used herein throughout the specification and claims, may be applied to modify any quantitative representation that could permissibly vary without resulting in a change in the basic function to which it is related. Accordingly, a value modified by a term or terms, such as “about,” “substantially”, is not limited to the precise value specified but within tolerances that are acceptable for the operation of the embodiment for an application for which it is intended. In some instances, the approximating language may correspond to the precision of an instrument for measuring the value.

The term “exemplary” may be used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ] , etc.). The term “a plurality” may be understood to include a numerical quantity greater than or equal to two (e.g., two, three, four, five, [ . . . ] , etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of (objects)”, “multiple (objects)”) referring to a quantity of objects expressly refer to more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “first”, “second”, “third” detailed herein are used to distinguish one element from another similar element and may not necessarily denote order or relative importance, unless otherwise stated.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide a magnetic connection system. The magnetic connection system may include a first connector and a second connector configured to connect with the first connector so as to establish an electrical connection. The first connector may include a first magnetic element (e.g. made of ferromagnetic material) and the second connector may include a second magnetic element (e.g. permanent magnets or electrical magnets). When the first connector is brought into the proximity of the second connector, the magnetic attraction between the first magnetic element of the first connector and the second magnetic element of the second connector may magnetically attract (e.g. pull together) the first and second connectors. When the first connector is in electrial connection with the second connector (e.g. at a received position), the the magnetic attraction between the first magnetic element of the first connector and the second magnetic element of the second connector may further magnetically attract (e.g. hold together) the first and second connectors.

In some embodiments, the first magnetic element of the first connector may be made of ferromagnetic materials (e.g., iron, cobalt, nickel and some alloys or compounds containing one or more of these elements, certain rare-earh metals, steel, etc), that is, the first magnetic element may be magnetically attracted by magnets regardless of polarity of the magnets. The second magnetic element of the second connecotr may be permanent magnets or electrial magnets, capable of magnetically attracting the first magnetic element of the first connector. The second magnetic element of the second connecotr may include a pair of magnets have a same polarity or different polarities (e.g. one having north pole and the other having south pole).

According to some embodiments what are described herein, the first connector may include a first guiding component and the second connector may include a second guiding component. The second guiding component of the second connector may couple with the first guiding component of the first connector in a manner that the first connector is received by the second connector in a solitary predetermined direction. For example, the first guiding component of the first connector may include a groove (e.g. a recess) and the second guiding component of the second connector may include a stopper (e.g. a protrusion) such that when the first connector is receiving in the second connector, the stopper of the second connector slides in the groove of the first connector. The sliding movement may restrict the first connector is being received by the second connector in a solitary predetermined direction along the direction (e.g. a longitudal direction) of the groove of the first connector. The stopper of the second connector may include a surface (e.g. flat or sloped surface) to engage with a corresponding surface (e.g. flat or correspondingly sloped surface) of the groove of the first connector so as to maintain close surface contact when the first connector is being received (e.g. sliding) in the second connector. The stopper of the second connector may further block the first connector from moving further into the second connector at the received position, that is, a front side of the stopper may be blocked by a back inner side of the groove.

In addition, in some embodiments, the first connector may include a terminal assembly having a support and terminals. The terminals may be disposed on surfaces of the support and therefore protected by the support. That may mean when the first connector is being receiving by (e.g. inserting into) the second connector, the support of the terminal assembly of the first connector may prevent damages of the terminals of the terminal assembly of the first connector by inadvertently misaligning the first connector with the second connector, for example, the terminals are completely shielded (e.g. surrounded) by the support.

Furthermore, in some embodiments, the terminals of the terminal assembly of the first connector may include a detection pin and the second connector may include a detection terminal (e.g. including a single detection terminal or a pair of detection terminal). Once the detection pin of the first connector comes into connection with the detection terminal of the second connector, a connection signal may be sent to the magnetic connection system (e.g. by the detection pin of the first connector or the detection terminal of the second connector) that the first connector is received in the second connector and establish an electrical connection with the second connector (e.g. at the received position).

The following examples pertain to various aspects of the present disclosure.

Example 1 is a magnetic connection system, the system including: a first connector, wherein the first connector comprises a first magnetic element having a magnetic plane and a terminal assembly protruding from the magnetic plane of the first magnetic element, and wherein the terminal assembly comprises a first guiding component; a second connector configured to receive the first connector so as to establish an electrical connection, wherein the second connector comprises a receptacle configured to receive the first connector and a second magnetic element disposed adjacent to the receptacle of the second connector, and wherein the second connector comprises a second guiding component configured to couple with the first guiding component in a manner that the first connector is received by the second connector in a solitary predetermined direction non-parallel to the magnetic plane of the first magnetic element of the first connector.

In Example 2, the subject matter of Example 1 may optionally include that the first guiding component of the first connector comprises a recess and the second guiding component of the second connector is configured to slide in the recess of the first connector, or wherein the second guiding component of the second connector comprises a recess and the first guiding component of the first connector is configured to slide in the recess of the second connector.

In Example 3, the subject matter of Example 1 may optionally include that the second guiding component of the second connector comprises an elongated component having a longitudinal direction parallel to the solitary predetermined direction, or wherein the first guiding component of the first connector comprises an elongated component having a longitudinal direction parallel to the solitary predetermined direction.

In Example 4, the subject matter of Example 1 may optionally include that the second guiding component of the second connector comprises a protrusion extending from an inner surface of the receptacle of the second connector and is configured to block the first connector at a received position, or wherein the first guiding component of the first connector comprises a protrusion extending from a surface of the terminal assembly of the first connector and is configured to block the second connector at a received position.

In Example 5, the subject matter of Example 1 may optionally include that the second magnetic element of the second connector comprises a pair of magnets and the first magnetic element of the first connector comprises a ferromagnetic material capable of magnetic attraction to the pair of magnets of the second connector.

In Example 6, the subject matter of Example 5 may optionally include that the first magnetic element of the first connector is configured to abut the second magnetic element of the second connector by magnetic attraction when the first connector is received in the second connector.

In Example 7, the subject matter of Example 5 may optionally include that the pair of magnets of the second connector have a same polarity.

In Example 8, the subject matter of Example 1 may optionally include that the terminal assembly of the first connector further comprises a support, a first pair of terminals disposed on a first surface of the support and a second pair of terminals disposed on a second surface of the support opposite to the first surface of the support.

In Example 9, the subject matter of Example 8 may optionally include that the first guiding component of the first connector is disposed on the first surface of the support and between the first pair of terminals.

In Example 10, the subject matter of Example 8 may optionally include that the first guiding component of the first connector is disposed on an edge of the support further from the magnetic plane of the first magnetic element of the first connector.

In Example 11, the subject matter of Example 8 may optionally include that the terminal assembly of the first connector further comprises a detection pin disposed on the second surface of the support and between the second pair of terminals, wherein the detection pin is configured to connect with a pair of detection terminals of the second connector and send a connection signal when the first connector is received in the second connector.

In Example 12, the subject matter of Example 8 may optionally include that the first pair of terminals disposed on the first surface of the support comprise a first power terminal and a first ground terminal, and the second pair of terminals disposed on the second surface of the support comprise a second power terminal and a second ground terminal.

In Example 13, the subject matter of Example 12 may optionally include that the second connector comprises four pairs of terminals, each of the four pairs of terminals is configured to contact with one of the first, second power terminals and the first, second ground terminals of the first connector so as to establish the electrical connection.

In Example 14, the subject matter of Example 1 may optionally include that the first magnetic element of the first connector comprises an opening and the terminal assembly protrudes from the opening of the first magnetic element of the first connector.

Example 15 is a magnetic connector device for electrically connecting to an electronic device, including: a cable; and a first connector installed at one end of the cable for connecting to a second connector of the electronic device, the first connector comprising: a first magnetic element having a magnetic plane; and a terminal assembly protruding from the magnetic plane of the first magnetic element, wherein the terminal assembly comprises a first guiding component; wherein the first guiding component of the first connector is configured to couple with a second guiding component of the second connector of the electronic device in a manner that the first connector is connected to the second connector of the electronic device in a solitary predetermined direction non-parallel to the magnetic plane of the first magnetic element.

In Example 16, the subject matter of Example 15 may optionally include that the first guiding component of the first connector comprises a recess configured to at least partially enclose the second guiding component of the electronic device.

In Example 17, the subject matter of Example 15 may optionally include that the first magnetic element of the first connector comprises a ferromagnetic material capable of magnetic attraction by a magnetic force exerted by the electronic device.

In Example 18, the subject matter of Example 15 may optionally include that the terminal assembly of the first connector further comprises a support, a first pair of terminals disposed on a first surface of the support and a second pair of terminals disposed on a second surface of the support opposite to the first surface of the support.

In Example 19, the subject matter of Example 18 may optionally include that the terminal assembly of the first connector further comprises a detection pin disposed on the second surface of the support and between the second pair of terminals, wherein the detection pin is configured to connect with a detection terminal of the second connector of the electronic device and send a connection signal to the electronic device when the first connector is connected to the second connector of the electronic device.

Example 20 is an electronic device including: a second connector configured to receive a first connector of a magnetic connector device, the second connector comprising: a receptacle configured to receive the first connector; a second magnetic element disposed adjacent to the receptacle of the second connector; and a second guiding component, wherein the second guiding component is configured to couple with a first guiding component of the first connector of the magnetic connector device in a manner that the first connector is received by the second connector in a solitary predetermined direction non-parallel to a magnetic plane of a first magnetic element of the first connector.

In Example 21, the subject matter of Example 20 may optionally include the second guiding component of the second connector comprises an elongated component having a longitudinal direction parallel to the solitary predetermined direction.

In Example 22, the subject matter of Example 20 may optionally include that the second guiding component of the second connector comprises a protrusion extending from an inner surface of the receptacle of the second connector and is configured to block the first connector of the magnetic connector device at a received position.

In Example 23, the subject matter of Example 20 may optionally include that the second magnetic element of the second connector comprises a pair of magnets and wherein the pair of magnets of the second connector have a same polarity.

In various embodiments, the magnetic connection system will now be described by way of the following non-limiting examples.

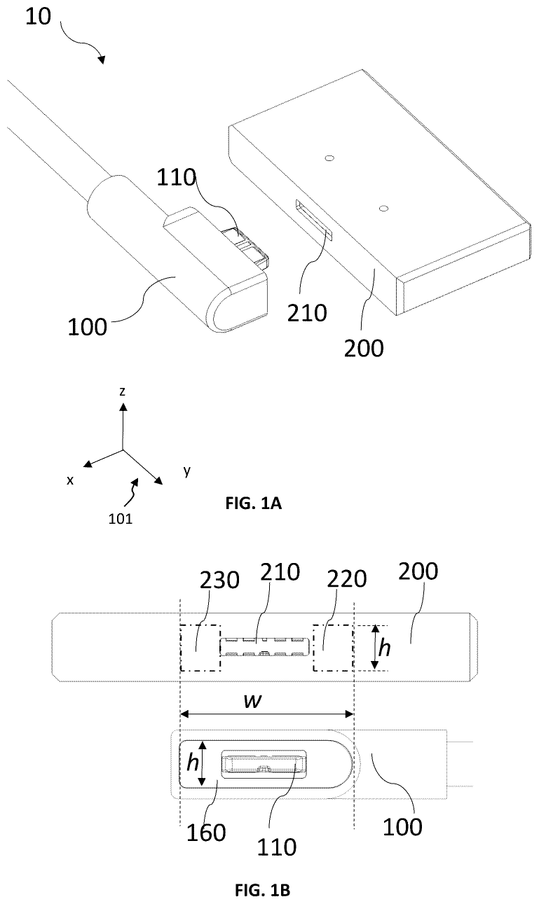

FIG. 1A shows a perspective view of an example magnetic connection system 100, according to various embodiments; FIG. 1B shows a side view of the example magnetic connection system 100, according to various embodiments. FIG. 1A as well as other figures as discussed below also shows a frame of reference 101 having three orthogonal axes. The frame of reference 101 includes a first axis in a first direction (e.g., the X-direction), a second axis in a second direction (e.g., the Y-direction), and a third axis in a third direction (e.g., the Z-direction). The first, second, and third directions are perpendicular to each other.

In the context of various embodiments, the term “magnetic connection system” refers to a system including at least two “magnetic connectors” and the two “magnetic connector” are attracted by magnetic force for maintaining contact. The two magnetic connectors may include a plug and a receptacle. In one embodiment, the plug and receptacle may be used as part of a power adapter for connecting an electronic device, such as a laptop computer, to a transformer connectable to a power supply. The plug may include a plurality of electrical terminals, which are preferably biased towards a corresponding plurality of terminals positioned on the receptacle. When the plug and receptacle are brought into proximity, the magnetic attraction may magnetically couple the plug and the receptacle and maintain the terminals in an electrically conductive relationship.

According to various non-limiting embodiments, the magnetic connection system 100 may include a first connector 100 and a second connector 200, the first connector 100 may be configured to connect with the second connector 200 so as to establish an electrical connection and vice versa. The first connector 100 may be a plug connectable to a first device or electrical relation and the second connector 200 may be a receptacle connectable to a second device or a receptacle in a second device. In one embodiment, the first device may be a transformer, and the second device may be an electronic device, such as a laptop computer, having a housing and internal electronics. Therefore, in one embodiment, the first connector 100 may be part of a power adapter for connecting the electronic device to a conventional AC power supply (not shown) with the transformer.

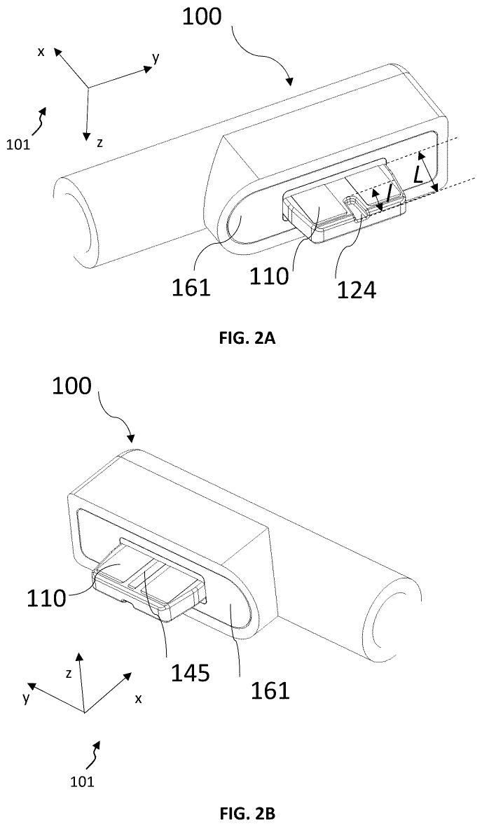

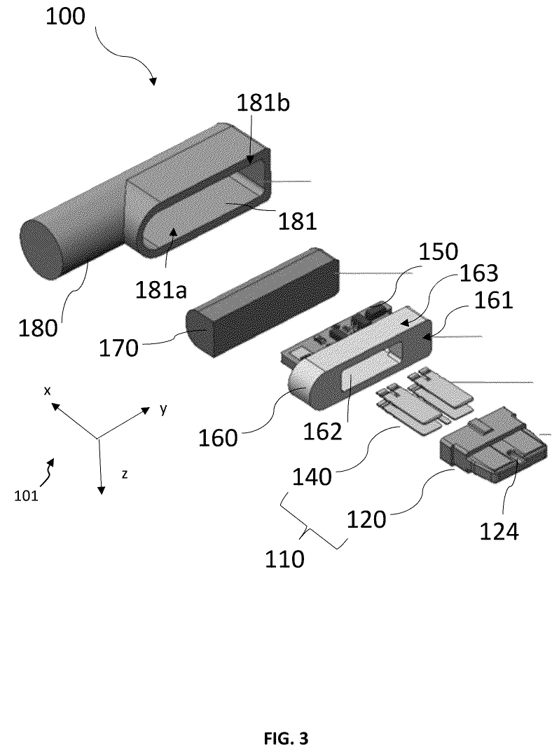

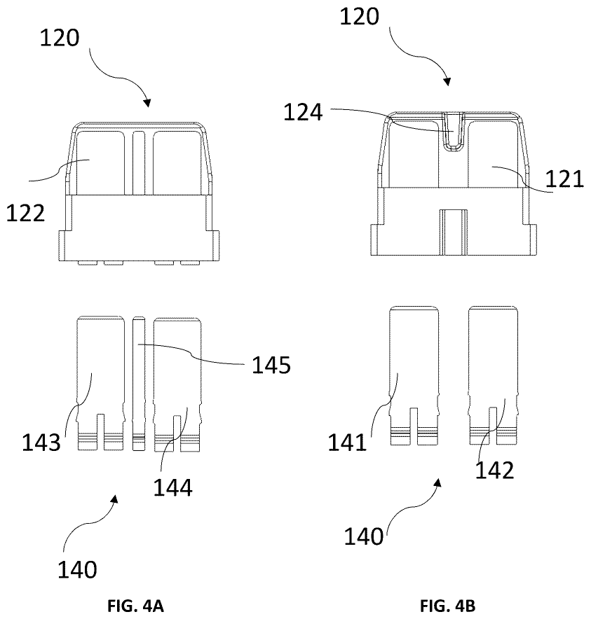

FIG. 2A shows a bottom perspective view of the first connector 100, according to various embodiments; and FIG. 2B shows a top perspective view of the first connector 100, according to various embodiments. FIG. 3 shows an exploded of the first connector 100, according to various embodiments. FIG. 4A shows a top view of a terminal assembly 110 of the first connector 100, according to various embodiments; FIG. 4B shows a bottom view of the terminal assembly 110 of the first connector 100, according to various embodiments.

With reference to FIGS. 2A-2B, 3 and 4A-4B, the first connector 100 will be described in more details.

According to various non-limiting embodiments, the first connector 100 may include a first magnetic element 160 having a magnetic plane 161 and a terminal assembly 110. The magnetic plane 161 of the first magnetic element 160 may include an opening 162 and the terminal assembly 110 may protrude from the opening 162 of the magnetic plane 161 of the first magnetic element 160. The first magnetic element 160 of the first connector 100 may be made of a ferromagnetic material capable of being attracted by magnets regardless of polarities.

According to various non-limiting embodiments, the terminal assembly 110 of the first connector 100 may include a support 120, a first pair of terminals 141, 142 disposed on a first surface 121 of the support 120 (e.g. FIG. 4B) and a second pair of terminals 143, 144 disposed on a second surface 122 of the support 120 opposite to the first surface 121 of the support 120 (e.g. FIG. 4A). The first pair of terminals 141, 142 disposed on the first surface 121 of the support 120 may include a first power terminal (e.g. 142) and a first ground terminal (e.g. 141), and the second pair of terminals 143, 144 disposed on the second surface 122 of the support 120 may include a second power terminal (e.g. 144) and a second ground terminal (e.g. 143). The support 120 may be provided to support the terminals 141, 142, 143, 144 to avoid damages.

According to various non-limiting embodiments, the terminal assembly 110 may include a first guiding component 124. The first guiding component 124 of the first connector 100 may include a recess disposed on first surface 121 of the support 120 (e.g. FIG. 4B). It shall be appreciated that the first guiding component 124 of the first connector 100 may include other structures other than a recess, for example, the first guiding component 124 of the first connector 100 may alternatively or additionally include a protrusion extended from first surface 121 of the support 120.

According to various non-limiting embodiments, the first guiding component 124 of the first connector 100 may be configured to guide a movement of the first connector along a movement direction when connecting with the second connector 200. Particularly, the first guiding component 124 of the first connector 100 may be configured to guide a solitary (e.g. single, sole) movement direction of the first connector when connecting with the second connector 200. That may mean that the first connector 100 may be configured to connect with the second connector 200 in a solitary (e.g. single, sole) movement direction and that any other direction may render the first connector 100 unable to connect with the second connector 200. That is, the first connector 100 may be restricted to connect with the second connector 200 in a solitary (e.g. single, sole) movement direction.

According to various non-limiting embodiments, referring to FIGS. 4A and 4B, the first guiding component 124 of the first connector 100 may be disposed on the first surface 121 of the support 120 and between the first pair of terminals 141, 142. The first guiding component 124 of the first connector 100 may be disposed on an edge of the support 120 further from the magnetic plane 161 of the first magnetic element 160 of the first connector 100. Accordingly, when the first connector 100 is brought to connect with the second connector 200, the edge of the support 120 where the first guiding component 124 of the first connector 100 is disposed may be first in contact with the second connector 200.

It should be appreciated that the first guiding component 124 of the first connector 100 may be disposed beside the first pair of terminals 141, 142, for example, to the right side of the terminal 142 or to the left side of the terminal 141. In one embodiment, the first guiding component 124 of the first connector 100 may include two parts with one (e.g. a recess or a protrusion) disposed to the right side of the terminal 142 and the other (e.g. a recess or a protrusion) disposed to the left side of the terminal 141. For example, the first guiding component 124 of the first connector 100 may include two parts with one (e.g. a recess) disposed to the right side of the terminal 142 and the other (e.g. a recess) disposed to the left side of the terminal 141. In another example, the first guiding component 124 of the first connector 100 may include two parts with one (e.g. a recess) disposed to the right side of the terminal 142 and the other (e.g. a protrusion) disposed to the left side of the terminal 141.

According to various non-limiting embodiments, the terminal assembly 110 of the first connector 100 may further include a detection pin 145 disposed on the second surface 122 of the support 120 and between the second pair of terminals 143, 144. The detection pin 145 may be configured to connect with a detection terminal (or a pair of detection terminals) of the second connector 200 and send a connection signal when the first connector 100 is received in the second connector 200. Likewise, it should be appreciated that the detection pin 145 of the first connector 100 may be disposed beside the first pair of terminals 143, 144, for example, to the right side of the terminal 144 or to the left side of the terminal 143.

Now referring to FIG. 3, according to various non-limiting embodiments, the first connector 100 may further include a housing 180 and optionally a buffer 170. The housing 180 may be configured to house the buffer 170 (e.g. optionally), the first magnetic element 160 (e.g. optionally attached with a printed circuit board (PCB) 150) and the terminal assembly 110. The housing 180 of the first connector 100 may include a cavity 181 having an opening 181a conformly shaped to an profile 163 of the first magnetic element 160. An edge 181b of the cavity 181 may be flush with the magnetic plane 161 of the first magnetic element 160.

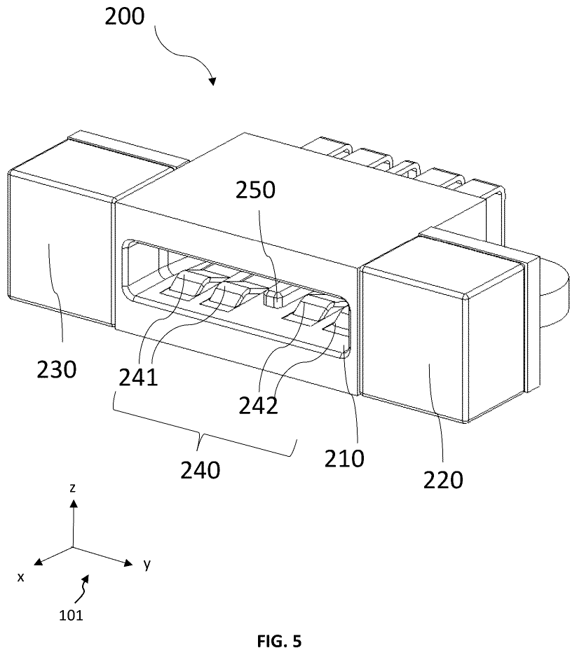

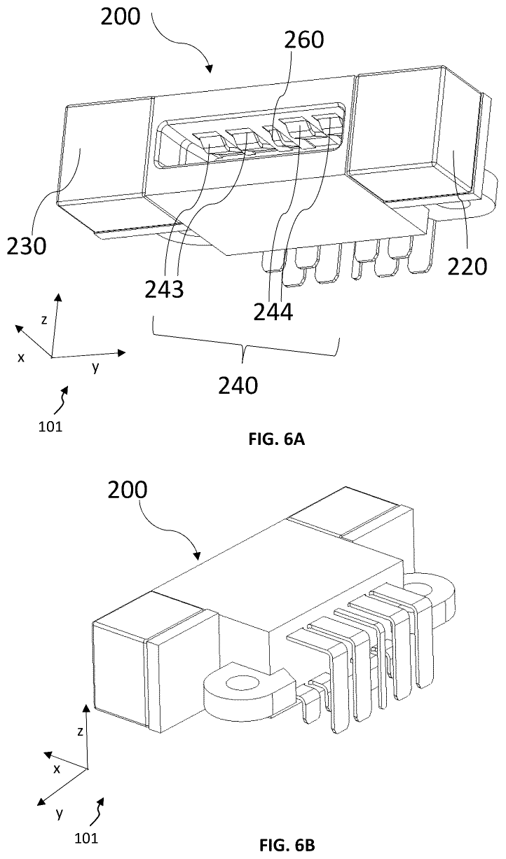

With reference to FIGS. 5 and 6A-6B, the second connector 200 will be described in more details.

According to various non-limiting embodiments, the second connector 200 may be configured to receive the first connector 100 so as to establish an electrical connection. The second connector 200 may include a receptacle 210 configured to receive the first connector 100 and a second magnetic element 220, 230, disposed adjacent to the receptacle 210 of the second connector 200. The second connector 200 may include a second guiding component 250 configured to couple with the first guiding component 124 in a manner that the first connector 100 is received by the second connector 200 in a solitary predetermined direction non-parallel to the magnetic plane 161 of the first magnetic element 160 of the first connector 100.

According to various non-limiting embodiments, the second guiding component 250 of the second connector 200 may include a protrusion extended from an internal surface of the receptacle 210 of the second connector 200, corresponding to a recess disposed on the first surface 121 of the support 120 of the first connector 100. It shall be appreciated that the second guiding component 250 of the second connector 200 may include other structures other than a protrusion, for example, the second guiding component 250 of the second connector 200 may alternatively or additionally include a recess disposed in the internal surface of the receptacle 210 of the second connector 200, corresponding to a protrusion extended from first surface 121 of the support 120 of the first connector 100.

According to various non-limiting embodiments, the second guiding component 250 of the second connector 200 may couple with the first guiding component 124 of the first connector 100 so as to guide a solitary (e.g. single, sole) movement direction of the first connector 100 when connecting with the second connector 200. In one embodiment, the second guiding component 250 of the second connector 200 may include a protrusion; the first guiding component 124 of the first connector 100 may include a corresponding recess in a manner that the protrusion of the second connector 200 is configured to slide in the recess of the first connector 100 in a direction parallel to the solitary movement direction when the first connector 100 is connecting to the second connector 200.

In various embodiments, the protrusion of the second connector 200 may be in an elongated shape having a longitudinal direction parallel to the solitary movement direction or having a longitudinal direction non-parallel (e.g. perpendicular) to the solitary movement direction.

In another embodiment, the second guiding component 250 of the second connector 200 may include a recess; the first guiding component 124 of the first connector 100 may include a corresponding protrusion in a manner that the protrusion of the first connector 100 is configured to slide in the recess of the second connector 200 in a direction parallel to the solitary movement direction when the first connector 100 is connecting to the second connector 200. In this embodiment, the recess of the second connector 200 may be disposed from an edge of the receptacle 210 of the second connector 200 and extend into the receptacle 210 of the second connector 200.

In the context of various embodiments, “a corresponding recess” to a protrusion and a “corresponding protrusion” to a recess refer to that the recess and the protrusion correspond to each other. That is, the protrusion may move along surface(s) of the recess while maintaining continuous contact with the recess such that the recess restricts or guides the movement of the protrusion. That may mean that when coupled, the recess at least partially encloses the protrusion.

In another embodiment, the second guiding component 250 of the second connector 200 may include a second recess and a second protrusion; the first guiding component 124 of the first connector 100 may include a corresponding first protrusion and a corresponding first recess. Accordingly, the first protrusion of the first connector 100 may be configured to slide in the second recess of the second connector 200 and the second protrusion of the second connector 200 configured to slide in the first recess of the first connector 100, in a sychronous manner and in a direction parallel to the solitary movement direction when the first connector 100 is connecting to the second connector 200. The first recess of the first connector 100 may be disposed on the second surface 122 of the support 120 of the first connector 100 and the first protrusion of the first connector 100 may be disposed on the first surface 121 of the support 120 of the first connector 100 in an opposing manner.

In one embodiment, the first recess of the first connector 100 may be disposed on the first surface 121 of the support 120 of the first connector 100 and the first protrusion of the first connector 100 may be disposed on the second surface 122 of the support 120 of the first connector 100 in an opposing manner. In another embodiment, the first recess and protrusion of the first connector 100 may be both disposed on the first surface 121 of the support 120 of the first connector 100. In another embodiment, the first recess and protrusion of the first connector 100 may be both disposed on the second surface 122 of the support 120 of the first connector 100. The second protrusion and recess of the second connector 200 may be disposed correspondingly in the receptacle 210 of the second connector 200.

According to various non-limiting embodiments, the first guiding component 124 of the first connector 100 may extend at a length (denoted as “1” in FIG. 2A) less than a full length (denoted as “L” in FIG. 2A) of the terminal assembly 110 protruded from the magnetic plane 161 of the first connector 100. The second guiding component 250 of the second connector 200 may be so designed that when the first connector 100 is received in the second connector 200 so as to establish the electrical connection, the second guiding component 250 of the second connector 200 is configured to block the first connector 100 at a received position (e.g. where the electrical connection is established). That is, the first connector 100 may not be prevented from moving further into the receptacle 210 of the second connector 200 by the second guiding component 250 of the second connector 200. For example, the second guiding component 250 of the second connector 200 may be specifically positioned or a length of the second guiding component 250 of the second connector 200 may be specifically set (e.g. 1=1/2L).

According to various non-limiting embodiments, the second magnetic element 220, 230 of the second connector 200 may include a pair of magnets 220, 230 (e.g. permanent magnets (preferably rare earth magnets) or electromagnets) and the first magnetic element 160 of the first connector 100 may include a ferromagnetic material capable of magnetic attraction to the pair of permanent magnets 220, 230 of the second connector 200. The pair of magnets 220, 230 of the second connector 200 may have a same polarity (e.g. either north pole or south pole).

Referring to FIGS. 5 and 6A, according to various non-limiting embodiments, the second connector 200 may include four pairs of terminals 240. Each of the four pairs of terminals 241, 242, 243, 244, may be configured to contact with one of the first, second power terminals (e.g. 142, 143) and the first, second ground terminals (e.g. 141, 144) of the first connector 100 so as to establish the electrical connection.

According to various non-limiting embodiments, the second connector 200 may include a detection terminal 260. The detection pin 145 of the first connector 100 may be configured to connect with the detection terminal 260 of the second connector 200 (e.g. at the received position) and send a connection signal that the first connector 100 is connected with the second connector 200. It should be appreciated that the detection terminal 260 of the second connector 200 may include a pair of detection terminals configured to be in contact with a top and a bottom of the detection pin 145 of the first connector 100, respectively. That is, the detection pin 145 of the first connector 100 may be sandwiched by the pair of detection terminals of the second connector 200 at the received position such that the first connector is in electrical connection with the second connector 200.

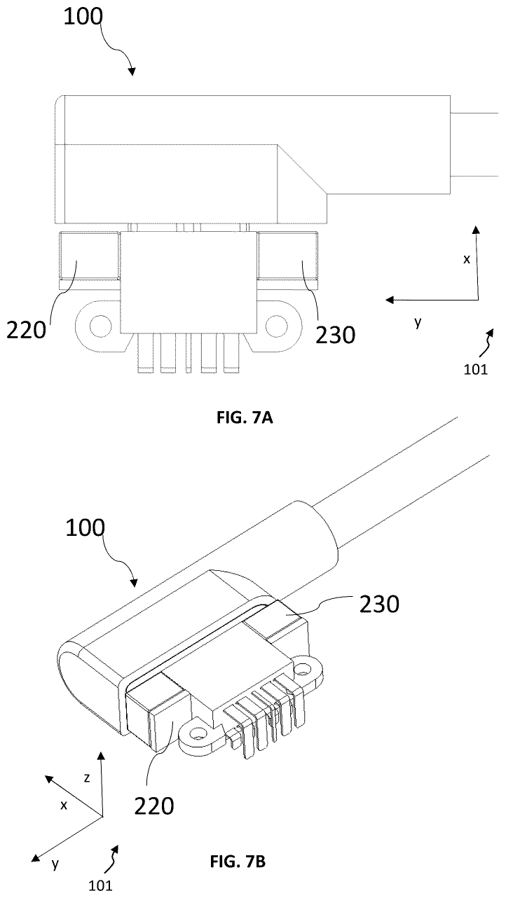

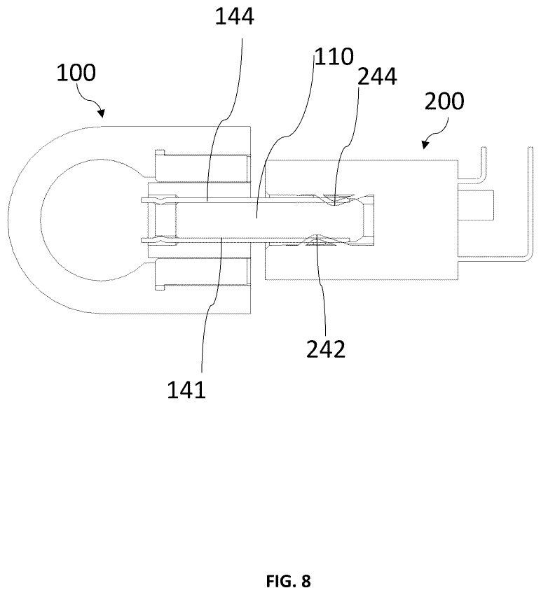

With reference to FIGS. 7A-7B and 8, the first connector 100 and the second connector 200 in connection will be described in more details.

According to various non-limiting embodiments, to make the electrical connection, the first connector 100 and the second connector 200 may be brought into proximity, the magnetic attraction between the first magnetic element 160 (e.g. ferromagnetic material) of the first connector 100 and the pair of magnets 220, 230 (e.g. permanent magnets or electromagnets) of the second connector 200 may magnetically draw the first connector 100 to the second connector 200 and magnetically pull (e.g. insert) the first connector 100 (e.g. the terminal assembly 110) into the second connector 200 (e.g. the receptacle 210 of the second connector 200) and hold the magnetically attracted first and second connectors 100, 200 together.

According to various non-limiting embodiments, in connection, the magnetic plane 161 of the first magnetic element 160 of the first connector 100 may be positioned (e.g. magnetically attracted) abutting the second magnetic element of the second connector 200. The terminals of the first connector 100 may engage the terminals of the second connector 200. To maintain the connection, the first magnetic element 160 of the first connector 100 and the second magnetic element 220, 230 of the second connector 200 may magnetically couple together and hold the first connector 100 to the receptacle 210 of the second connector 200.

According to various non-limiting embodiments, a width of the first magnetic element 160 of the first conenctor 100 (e.g. denoted as w in FIG. 1B) may be correspondingly similar to or less than a span from a left edge of the magnet 230 (denoted in dash line as it is invisible in FIG. 1B), across the receptacle 210, to a right edge of the magnet 220 (denoted in dash line as it is invisible in FIG. 1B) of the second connector 200 in a manner that in connection, the first magnetic element 160 directly face the second magnetic element 220, 230 of the second connector 200. Likewise, a height of the first magnetic element 160 of the first conenctor 100 (e.g. denoted as h in FIG. 1B) may be correspondingly similar to or less than a height from an upper edge of the magnets 220, 230 to a lower edge of the magnets 220, 230 of the second connector 200. Accordingly, in connection, the first magnetic element 160 may directly face (e.g. match) the second magnetic element 220, 230 of the second connector 200. The magnet 220 may be in alignment with the magnet 230 of the second connector 200 with respect to the receptacle 210 of the second connector 200.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A magnetic connection system, the system comprising:
a first connector, wherein the first connector comprises a first magnetic element having a magnetic plane and a terminal assembly protruding from the magnetic plane of the first magnetic element, and wherein the terminal assembly comprises a first guiding component;
a second connector configured to receive the first connector so as to establish an electrical connection, wherein the second connector comprises a receptacle configured to receive the first connector and a second magnetic element disposed adjacent to the receptacle of the second connector, and wherein the second connector comprises a second guiding component configured to couple with the first guiding component in a manner that the first connector is received by the second connector in a solitary predetermined direction non-parallel to the magnetic plane of the first magnetic element of the first connector.

2. The magnetic connection system of claim 1, wherein the first guiding component of the first connector comprises a recess and the second guiding component of the second connector is configured to slide in the recess of the first connector, or wherein the second guiding component of the second connector comprises a recess and the first guiding component of the first connector is configured to slide in the recess of the second connector.

3. The magnetic connection system of claim 1, wherein the second guiding component of the second connector comprises an elongated component having a longitudinal direction parallel to the solitary predetermined direction, or wherein the first guiding component of the first connector comprises an elongated component having a longitudinal direction parallel to the solitary predetermined direction.

4. The magnetic connection system of claim 1, wherein the second guiding component of the second connector comprises a protrusion extending from an inner surface of the receptacle of the second connector and is configured to block the first connector at a received position, or wherein the first guiding component of the first connector comprises a protrusion extending from a surface of the terminal assembly of the first connector and is configured to block the second connector at a received position.

5. The magnetic connection system of claim 1, wherein the second magnetic element of the second connector comprises a pair of magnets and the first magnetic element of the first connector comprises a ferromagnetic material capable of magnetic attraction to the pair of magnets of the second connector.

6. The magnetic connection system of claim 5, wherein the first magnetic element of the first connector is configured to abut the second magnetic element of the second connector by magnetic attraction when the first connector is received in the second connector.

7. The magnetic connection system of claim 5, wherein the pair of magnets of the second connector have a same polarity.

8. The magnetic connection system of claim 1, wherein the terminal assembly of the first connector further comprises a support, a first pair of terminals disposed on a first surface of the support and a second pair of terminals disposed on a second surface of the support opposite to the first surface of the support.

9. The magnetic connection system of claim 8, wherein the first guiding component of the first connector is disposed on the first surface of the support and between the first pair of terminals.

10. The magnetic connection system of claim 8, wherein the first guiding component of the first connector is disposed on an edge of the support further from the magnetic plane of the first magnetic element of the first connector.

11. The magnetic connection system of claim 8, wherein the terminal assembly of the first connector further comprises a detection pin disposed on the second surface of the support and between the second pair of terminals, wherein the detection pin is configured to connect with a pair of detection terminals of the second connector and send a connection signal when the first connector is received in the second connector.

12. The magnetic connection system of claim 8, wherein the first pair of terminals disposed on the first surface of the support comprise a first power terminal and a first ground terminal, and the second pair of terminals disposed on the second surface of the support comprise a second power terminal and a second ground terminal.

13. The magnetic connection system of claim 12, wherein the second connector comprises four pairs of terminals, each of the four pairs of terminals is configured to contact with one of the first, second power terminals and the first, second ground terminals of the first connector so as to establish the electrical connection.

14. The magnetic connection system of claim 1, wherein the first magnetic element of the first connector comprises an opening and the terminal assembly protrudes from the opening of the first magnetic element of the first connector.

15. A magnetic connector device for electrically connecting to an electronic device, comprising:
a cable; and
a first connector installed at one end of the cable for connecting to a second connector of the electronic device, the first connector comprising:
a first magnetic element having a magnetic plane; and
a terminal assembly protruding from the magnetic plane of the first magnetic element, wherein the terminal assembly comprises a first guiding component;
wherein the first guiding component of the first connector is configured to couple with a second guiding component of the second connector of the electronic device in a manner that the first connector is connected to the second connector of the electronic device in a solitary predetermined direction non-parallel to the magnetic plane of the first magnetic element.

16. (canceled)

17. (canceled)

18. The magnetic connector device of claim 15, wherein the terminal assembly of the first connector further comprises a support, a first pair of terminals disposed on a first surface of the support and a second pair of terminals disposed on a second surface of the support opposite to the first surface of the support.

19. (canceled)

20. An electronic device comprising:
a second connector configured to receive a first connector of a magnetic connector device, the second connector comprising:
a receptacle configured to receive the first connector;
a second magnetic element disposed adjacent to the receptacle of the second connector; and
a second guiding component,
wherein the second guiding component is configured to couple with a first guiding component of the first connector of the magnetic connector device in a manner that the first connector is received by the second connector in a solitary predetermined direction non-parallel to a magnetic plane of a first magnetic element of the first connector.

21. The electronic device of claim 20, wherein the second guiding component of the second connector comprises an elongated component having a longitudinal direction parallel to the solitary predetermined direction.

22. The electronic device of claim 20, wherein the second guiding component of the second connector comprises a protrusion extending from an inner surface of the receptacle of the second connector and is configured to block the first connector of the magnetic connector device at a received position.

23. The electronic device of claim 20, wherein the second magnetic element of the second connector comprises a pair of magnets and wherein the pair of magnets of the second connector have a same polarity.
